(19) United States
(12) Patent Application Publication
(10) Pub. No.: US 2021/0008947 A1
(43) Pub. Date: Jan. 14, 2021

(54) WHEEL SUSPENSION FOR A MOTOR VEHICLE, MOTOR VEHICLE AND METHOD FOR OPERATING A WHEEL SUSPENSION OF THIS KIND

(71) Applicant: AUDI AG, Ingolstadt (DE)

(72) Inventors: Achim GLAS, Gaimersheim (DE); Wolfgang SCHMID, Freising (DE)

(73) Assignee: AUDI AG, Ingolstadt (DE)

(21) Appl. No.: 16/977,560

(22) PCT Filed: Feb. 5, 2019
(86) PCT No.: PCT/EP2019/052815

§ 371 Date: Sep. 2, 2020

(30) Foreign Application Priority Data
Mar. 7, 2018 (DE) 10 2018 203 452.4

(51) Int. Cl. B60G 17/02; B60G 11/14; B60G 17/015; B60G 17/027

(52) U.S. Cl. CPC B60G 17/021; B60G 11/14; B60G 17/015; B60G 17/0272; B60G 2202/12; B60G 2500/30; B60G 2202/42; B60G 2206/7101; B60G 2400/60; B60G 2500/22; B60G 2202/413

(57) ABSTRACT

A wheel suspension for a motor vehicle having a body and at least one wheel and supportable via the wheel on a roadway, having at least one spring element having a progressive spring characteristic curve, via which the wheel is supportable in a spring-loaded manner on the body, wherein a vertical adjustment device is provided, by which the body is vertically adjustable, while a change of the spring rate of the spring element does not occur.

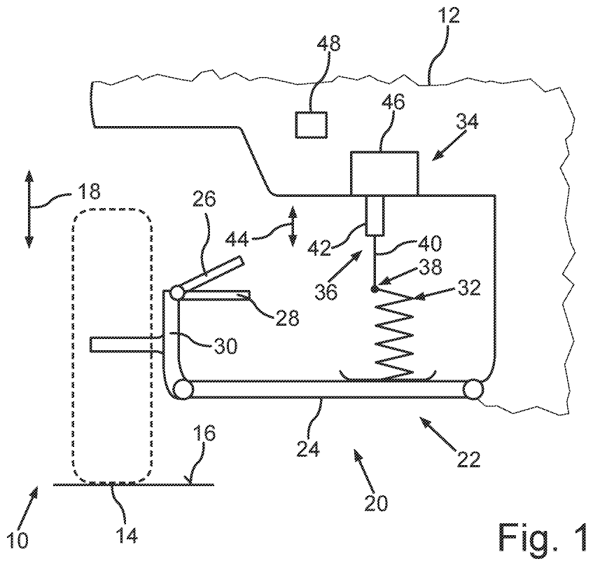

The invention relates to a wheel suspension for motor vehicle according to the preamble of claim 1. Furthermore, the invention relates to a motor vehicle according to the preamble of claim 10. Moreover, the invention relates to a method for operating a wheel suspension of this kind.

Such a wheel suspension for a motor vehicle and such a motor vehicle having such a wheel suspension can be inferred to be already known, for example, DE 10 2009 020 108 A1. The motor vehicle has a body designed as a self-supporting vehicle body, for example, in which persons, for example, the driver of the motor vehicle, can be located. Moreover, the vehicle has at least one or more wheels, wherein the body or the motor vehicle as a whole is supportable via the respective wheel on a roadway for the motor vehicle. Furthermore, the motor vehicle has a wheel suspension, which comprises at least one spring element having a progressive spring characteristic curve. The wheel is supportable or supported here in a spring-loaded manner via the spring element on the body.

Furthermore, DE 10 2006 010 054 A1 discloses a wheel suspension, having a spring adjustment for a motor vehicle, the vehicle body of which is proportionally supported via at least one coiled compression spring finally on a wheel mount or the like movably linked via a suspension arm arrangement on the body.

In addition, a wheel suspension is known from EP 1 666 282 B 1, which comprises a vehicle body and a wheel linked movably thereon via a suspension arm arrangement having a wheel mount and at least one coiled compression spring, which is supported on the vehicle body, on the one hand, and on the wheel mount or suspension arm arrangement, on the other hand.

The object of the present invention is to provide a wheel suspension, a motor vehicle, and a method, so that a particularly high level of driving comfort can be implemented, in particular also with different load states of the body.

This object is achieved according to the invention by a wheel suspension having the features of claim 1, by a motor vehicle having the features of claim 10, and by a method having the features of claim 11. Advantageous designs having expedient refinements of the invention are specified in the remaining claims.

The first aspect of the invention relates to a wheel suspension for a motor vehicle, which has a body and at least one wheel and is supportable via the wheel on a roadway, and which is preferably designed as an automobile, in particular as a passenger vehicle. In its completely produced state, the motor vehicle has the body designed, for example, as a self-supporting vehicle body. Moreover, the motor vehicle has in its completely produced state the at least one wheel or multiple wheels, wherein the body or the motor vehicle as a whole is supportable or supported via the respective wheel in the vehicle vertical direction downwards on the roadway. If the motor vehicle is driven along the roadway in its state supported via the respective wheel on the roadway, the respective wheel thus rolls on the roadway.

The wheel suspension has at least one spring element having a progressive spring characteristic curve, wherein the at least one wheel is supportable or supported via the spring element in a spring-loaded manner on the body. In the completely produced state of the motor vehicle, the wheel is held movably on the body, so that the wheel can move at least in the vehicle vertical direction in relation to the body. The spring element permits relative movements extending in the vehicle vertical direction between the wheel and the body, so that the wheel can retract and extend in the vehicle vertical direction in relation to the body. During a retraction, the wheel moves in the vehicle vertical direction in relation to the body and in the direction of the body at the same time, whereby, for example, the spring element is tensioned, in particular compressed. During an extension, the wheel moves downward in the vehicle vertical direction and away from the body at the same time, whereby, for example, the spring element is relaxed and/or extended. In particular, the spring element is designed as a compression spring element.

To now be able to implement a particularly high level of driving comfort and also particularly advantageous driving behavior of the motor vehicle at the same time, in particular also in different load states of the body, it is provided according to the invention that the wheel suspension has a vertical adjustment device, by means of which the body is vertically adjustable, while a change of the spring rate of the spring element does not occur. In other words, the body is vertically adjustable, in particular in relation to the roadway, by means of the vertical adjustment device, i.e., is movable in the vehicle vertical direction without the spring rate of the spring element being changed in this case. By means of the vertical adjustment device, for example, in a state in which the body is supported via the wheel on the roadway, a distance extending in the vehicle vertical direction between the body and the roadway is thus settable, adjustable, or variable. In other words, the feature that the body is vertically adjustable by means of the vertical adjustment device is to be understood to mean that the previously described distance can be set, adjusted, or varied, respectively. Furthermore, the feature that the body is vertically adjustable by means of the vertical adjustment device is to be understood to mean that the body is intentionally or actively vertically adjustable by means of the vertical adjustment device, so that a so-called static vertical adjustment or vertical adjustability is implementable or implemented by means of the vertical adjustment, in the scope of which the body is intentionally or actively vertically adjusted by means of the vertical adjustment device, i.e., moved in the vertical direction in relation to the roadway and moved away from the roadway or alternately toward the roadway at the same time, without the spring rate of the spring element changing.

Upon the vertical adjustment of the body, a change of the spring rate of the spring element does not occur in particular in that, upon or during the vertical adjustment of the body, a length change of the spring element does not occur, in particular along its force action line and/or along its geometrical spring center line. Expressed in still other words, a vertical adjustment of the body is not accompanied by a length change of the spring element, so that the spring rate is not changed.

As is generally known and routine, the spring characteristic curve describes the relationship between a deformation, extending in particular along the force action line and/or the geometrical spring center line of the spring element, in particular a length change, of the spring element, and a spring force resulting from the deformation and provided by the spring element, wherein the spring characteristic curve of the spring element is progressive according to the invention. The spring force provided by the spring element therefore increases disproportionately with increasing compression of the spring element. The spring rate of the spring element is to be understood here as the respective local slope of the spring characteristic curve associated with a respective deformation, in particular compression, of the spring element, so that the spring rate is less, for example, in a first state of the spring element than in a second state of the spring element, which is compressed more strongly in the second state than in the first state.

If, for example, the body is initially unloaded, while the body is supported via the at least one wheel on the roadway, which extends at least essentially horizontally, for example, the spring element is thus initially located, for example, in the first state, in which the spring element is completely relaxed or is compressed and is thus tensioned. In particular, the spring element is slightly tensioned, for example, in the first state, in particular slightly compressed or pressed together. If then, for example, the body is loaded, while a vertical adjustment of the body does not occur, the body thus initially sinks. This means that the body moves downward in the direction of the roadway in the vehicle vertical direction. In this way, the spring element is tensioned starting from the first state, in particular compressed, and thus brought, for example, into the above-described second state, in which the spring element is more strongly tensioned, in particular more strongly compressed in relation to the first state. The spring rate thus has a first value in the first state and a second value, which is greater than the first value, in the second state. In other words, the spring rate in the second state is greater than in the first state. Such an increase of the spring rate with increasing load of the body, i.e., with increasing weight of a system comprising the body and a load of the body, it is desirable, for example, to keep the natural frequency of the body, which is also referred to as the vehicle body, at least essentially equal or constant in spite of increasing load or in spite of higher mass of the motor vehicle. As a result, a particularly advantageous and in particular safe driving behavior can be ensured.

To now maintain this increase of the spring rate of the spring element resulting from the increasing load of the body, which is also referred to as cargo load, at the same time be able to implement a sufficient vehicle height or a sufficient ground clearance of the motor vehicle, the body can be moved upward away from the roadway in the vehicle vertical direction by means of the vertical adjustment device—while the second state of the spring element is maintained. In this way, for example, while maintaining the higher spring rate of the spring element resulting from the cargo load, a particularly high level of driving comfort can be ensured. This implementation of a high level of driving comfort and safer driving behavior is possible here without the use of an air spring, so that it is preferably provided that the spring element is designed as a mechanical spring element or as a mechanical spring, in particular as a meandering spring. The invention is based on the following finding here:

The use of air springs as body springs, via which wheels are supported in a spring-loaded manner on vehicle bodies of motor vehicles, is well known. Air springs, in relation to conventional, mechanical springs, can compensate for the compression upon increasing load of the body via the increase of their internal pressure. On the one hand, this has the effect that the motor vehicle again reaches its normal ride height. On the other hand, the pressure elevation or the pressure increase results in an increase of the spring rate of the respective air spring. This increase of the spring rate, in particular in conjunction with a controllable or variable shock absorber, ideally results in a uniform natural frequency of the vehicle body in spite of higher vehicle mass due to the increasing load. A load compensation can thus be implemented, due to which the body spring, also referred to as a suspension spring, can be designed to be particularly soft per se for the unloaded or empty motor vehicle, so that a particularly high level of comfort can be implemented in relation to conventional steel springs.

Conventional steel springs already have to have a higher spring rate here for the unloaded motor vehicle, so that with increasing load of the motor vehicle, it does not compress excessively strongly and thus a sufficient remaining spring travel is provided. In both spring variants, the spring rate is increased over the compression travel by means of auxiliary springs, which are also referred to as buffers, so that an upper stop is only reached at designed maximum force. In the conventional steel spring, the buffer is also required to strongly increase the spring rate in the event of cargo load and to reduce the compression travel. The buffer, which is also referred to as an auxiliary buffer, is connected in parallel to the actual suspension spring and only becomes active from a specific compression, resulting in particular from a load of the body. When the buffer is applied or becomes active, this results in a jump in the overall spring rate, which can have a negative effect on the driving comfort.

Air springs, in contrast, have negative properties in comfort technology in addition to their advantage. The following equation shows the relationship between the spring stiffness of the air spring and the pressure prevailing in the air spring, the gas or air volume accommodated therein, the active area, and the polytropic exponent:

$$c = \frac{n \cdot p \cdot {A}^{2}}{V}$$

In this case, c denotes the spring rate, n denotes the polytropic exponent, p denotes the pressure, A denotes the active area, and V denotes the volume. If the air spring is slowly pressed together or compressed, the polytropic exponent is thus 1. If the frequency increases to 1 Hz, for example, which is in the range of the typical body frequency, the polytropic exponent increases to 2. The result is that the air spring hardens dynamically, so that its spring rate increases. This has a negative effect on the comfort, the higher forces during a compression reach the body designed as a self-supporting vehicle body, for example.

To avoid the above-mentioned disadvantages in problems, according to the invention, instead of a conventional air spring, the spring element functioning as a body spring or suspension spring having progressive spring characteristic curve is used, so that the spring element is a progressive spring element, i.e., a progressive body spring. Furthermore, the above-described static vertical adjustment is provided. Due to the combination according to the invention of the progressive body spring with the static vertical adjustment, the advantages of an air spring can be used without the disadvantage of the dynamic hardening of the air spring. Due to the use of the progressive body spring and a static vertical adjustment, in particular the following two advantages of an air spring can be implemented: load compensation via static vertical adjustment and suspension spring having lower spring rate around the empty height for maximizing comfort.

The load compensation via the static vertical adjustment is to be understood to mean that—as described above—the body, which sinks due to increasing load and thus approaches the roadway, can be moved in the vertical direction upward away from the roadway again, to thus set a ride height of the motor vehicle as in the unloaded state. In other words, it is possible by way of the static vertical adjustment that the motor vehicle in the loaded state of its body assumes or has the same ride height and thus the same ground clearance as in the unloaded state of the body. The above-mentioned suspension spring having lower spring rate around the empty height for maximizing comfort is to be understood to mean that the progressive body spring also referred to as a suspension spring can be designed to be particularly soft for the unloaded state of the body, so that the spring rates in the undeformed state of the spring element and in the only slightly deformed state are significantly less than in the more strongly deformed state of the spring element in relation thereto. If the body and thus the motor vehicle are then unloaded or only slightly loaded, due to the fundamentally soft design of the spring element, a particularly high level of driving comfort can thus be implemented.

A further advantage of the progressive body spring is that its spring rate increases progressively or exponentially with increasing load of the body, so that an adaptation of the oscillation rate can be implemented.

In one particularly advantageous embodiment of the invention, the mechanical spring element, i.e., the spring element different from a pneumatic spring, is formed from a fiber-reinforced plastic, whereby the progressive spring characteristic curve can be implemented particularly advantageously.

It has been shown to be particularly advantageous here if the fiber-reinforced plastic is a glass-fiber-reinforced plastic (GFRP).

In a further design of the invention, the spring element is designed as a meandering spring.

In progressive springs, in particular in progressive steel springs, the progressive spring characteristic curve or its progression is implemented by different slopes of the turns of the spring, wherein the turns are formed, for example, by a spring wire. This typically has the result that with increasing retraction and thus with increasing compression of the progressive spring, more and more turns mutually touch and are thus deactivated. The deactivation is to be understood to mean that the mutually touching and thus deactivated turns no longer participate in springing or in an elastic deformation of the spring. The mutual touching of the individual turns, which are also referred to as spring coils, results in damage to a conventionally provided paint layer, however, which is applied to the turns per se or to a base body forming the turns. A corrosion of the spring, which is formed from steel, for example, can result therefrom, which can lead to failure, in particular fracture of the spring. The above-mentioned disadvantages and problems can be avoided by forming the spring element from a fiber-reinforced plastic, in particular from a glass-fiber-reinforced plastic.

To be able to implement the vertical adjustment particularly simply, efficiently, and effectively, it is provided in a further design of the invention that the vertical adjustment device has at least one adjustment element, the length of which is adjustable, whereby the body is vertically adjustable, while a change of the spring rate of the spring element does not occur. In other words, to vertically adjust the body, the length of the adjustment element is adjusted, i.e., varied or changed. By increasing the length of the adjustment element, the body is, for example, moved upward in the vehicle vertical direction away from the roadway. By reducing the length of the adjustment element, for example, the body is lowered and thus moved in the vehicle vertical direction in the direction of the roadway.

It has proven to be particularly advantageous here if the adjustment element is arranged, with respect to a force flow extending from the body via the spring element and the adjustment element to the wheel, between the body and the spring element or between the wheel and the spring element. If the adjustment element is arranged, for example, between the body and the spring element, the body is thus raised, for example, i.e., thus moved in the vehicle vertical direction away from the roadway, such that the body is moved upward away from the spring and the wheel in the vehicle vertical direction with length enlargement of the adjustment element. To lower the body, with length reduction of the adjustment element, the body is moved downward in the vehicle vertical direction in the direction of the spring and in the direction of the wheel.

If, for example, the adjustment element is arranged between the wheel and the spring element, thus, for example, the body is raised in that with length enlargement or with length increase of the adjustment element, the spring and the body are moved in the vehicle vertical direction upward away from the wheel or in relation to the wheel and at the same time away from the roadway. To lower the body, for example, with length decrease or length reduction of the adjustment element, the spring element and the body are moved in the vehicle vertical direction downward in the direction of the wheel or in relation to the wheel in the direction of the roadway. By way of this arrangement of the adjustment element, the body can be raised and lowered particularly effectively and efficiently and with only a minor force requirement.

A further embodiment is distinguished in that the vertical adjustment device, in particular the adjustment element, is hydraulically and/or electrically operable, so that the body is hydraulically and/or electromechanically adjustable. For the hydraulic vertical adjustment of the body, for example, a hydraulic liquid is introduced into a chamber, whereby a length increase of the adjustment element is effectuated. The body is raised in this way. For example, to lower the body, at least a part of the hydraulic liquid accommodated in the chamber is discharged from the chamber. For this purpose, the adjustment element comprises a cylinder, in particular a hydraulic cylinder, into the chamber of which the hydraulic liquid can be introduced. In relation to a pneumatic vertical adjustment, the hydraulic and the electromechanical vertical adjustment is advantageous since, for example, by means of the hydraulic or electromechanical vertical adjustment, undesired spring movements and length shortenings of the adjustment element resulting therefrom, which can result, for example, from a compression of a gas accommodated in the chamber, can be avoided.

To implement the electromechanical vertical adjustment, the adjustment element has, for example, a threaded spindle as a first component and a corresponding nut arranged on the threaded spindle as a second component, wherein the threaded spindle has a first thread in the form of an external thread and the nut has a second thread in the form of an internal thread corresponding to the external thread. The nut is screwed onto the threaded spindle and screwed together with the threaded spindle. Furthermore, the adjustment element comprises, for example, at least one electric motor, by means of which a relative rotation can be effectuated between the threaded spindle and the nut. In other words, the threaded spindle and the nut can be rotated in relation to one another by means of the electric motor. In particular, the threaded spindle and the nut can be rotated in relation to one another around a rotational axis by means of the electric motor, wherein it is preferably provided that one of the components is rotatable around the rotational axis, while the respective other component is secured against rotations extending around the rotational axis. In this way, the one component can be rotated by means of the electric motor in relation to the other component, while rotations of the other component extending around the rotational axis are avoided. Thus, for example, if the one component is rotated by means of the electric motor in a first rotational direction in relation to the other component, these relative rotations are thus converted by means of the thread into translational relative movements between the components, so that, for example, the nut is moved translationally in relation to the threaded spindle and along the threaded spindle.

If, for example, the one component is rotated by means of the electric motor in a first rotational direction, thus, for example, the nut is translationally moved in a first direction in relation to the threaded spindle. In this way, for example, a length increase of the adjustment element is effectuated. If, for example, the one component is rotated in a second rotational direction opposite to the first rotational direction in relation to the other component by means of the electric motor, thus, for example, a translational movement of the nut in relation to the threaded spindle in a second direction opposite to the first direction is effectuated in this way. In this way, for example, a length shortening of the adjustment element is effectuated. One of the components is at least indirectly, in particular directly, connected to the spring here, while the other component is connected indirectly, in particular directly, to the body. This is provided in particular if the adjustment element is arranged between the spring and the body. If the adjustment element is arranged, for example, between the spring and the wheel, one of the components is thus connected, for example, at least indirectly, in particular directly, to the wheel, while the other component is connected at least indirectly, in particular directly, to the spring element. If, for example, the one component is rotated by means of the electric motor in the first rotational direction, thus, for example, the body is moved in the vehicle vertical direction upward away from the roadway. However, if the one component is rotated by means of the electric motor in the second rotational direction, thus, for example, the body is lowered and thus moved in the vehicle vertical direction in the direction of the roadway.

The adjustment element can thus have at least two adjustment parts, which are movable in relation to one another, in particular translationally, for the vertical adjustment of the body. For example, to raise the body, one of the adjustment parts is moved in a first direction translationally in relation to the other adjustment part. For example, to lower the body, for example, the one adjustment part is moved translationally in relation to the other adjustment part in a second direction opposite to the first direction. One of the adjustment parts can be the above-mentioned nut in this case, while the other adjustment part is the threaded spindle or vice versa. The adjustment parts are, for example, moved hydraulically and/or electrically in relation to one another, so that a hydraulic and/or preferably electromechanical vertical adjustment of the body can be represented.

A further embodiment is distinguished in that the wheel suspension according to the invention comprises the body and the wheel.

To implement a particularly high level of driving comfort, it is provided in a further design of the invention that the wheel suspension comprises an electronic computing unit, which is designed to ascertain a load of the body, to activate the vertical adjustment device in dependence on the ascertain load and thus to effectuate a vertical adjustment of the body, while a change of the spring rate of the spring element does not occur. In this way, the vertical adjustment of the body is automatically effectuated, for example, by means of the electronic computing unit, so that the desired ride height of the body or the motor vehicle as a whole can be set automatically, in particular to a predefinable value. Thus, for example, the ride height can be set in such a way that the motor vehicle has the same right height in the loaded state as in the unloaded state. An action of the driver of the motor vehicle is not required for this purpose. Of course, it is conceivable that the electronic computing unit is designed to detect at least one input effectuated by a person, to control the vertical adjustment device in dependence on the detected input, and thus to effectuate a vertical adjustment of the body, in particular while a change of the spring rate of the spring element does not occur. The person can effectuate the input, for example, via at least one operating element of the motor vehicle. In this way, for example, the driver of the motor vehicle can set a ride height desired by him or a ground clearance desired by him. Expressed in other words, for example, the driver can raise and lower the body as needed.

A second aspect of the invention relates to a motor vehicle, preferably designed as an automobile, in particular as a passenger vehicle, which has a body preferably designed as a self-supporting vehicle body and at least one wheel or multiple wheels. The body is supportable, in particular downward in the vehicle vertical direction, on a roadway for the motor vehicle via the respective wheel. The motor vehicle furthermore comprises a wheel suspension, in particular a wheel suspension according to the invention. The wheel suspension comprises at least one spring element having a progressive spring characteristic curve, via which the respective wheel is supported in a spring-loaded manner on the body.

To now be able to implement a particularly high level of driving comfort, according to the invention, a vertical adjustment device is provided, by means of which the body is vertically adjustable, in particular in relation to the roadway, while a change of the spring rate of the spring element does not occur. Advantages and advantageous designs of the first aspect of the invention are to be considered advantages and advantageous designs of the second aspect of the invention and vice versa.

A third aspect of the invention relates to a method for operating a wheel suspension, in particular a wheel suspension according to the invention, of a motor vehicle having a body and at least one wheel and supportable via the wheel, in particular downward in the vertical direction, on a roadway. In the method, the wheel suspension comprises at least one spring element having a progressive spring characteristic curve, via which the wheel is supported in a spring-loaded manner on the body. In the method, the body is vertically adjusted, in particular in relation to the roadway, by means of a vertical adjustment device of the motor vehicle, while a change of the spring rate of the spring element does not occur. Advantages and advantageous designs of the first aspect and the second aspect of the invention are to be considered advantages and advantageous designs of the third aspect of the invention and vice versa.

Further advantages, features, and details of the invention result from the following description of a preferred exemplary embodiment and on the basis of the drawings. The features and feature combinations mentioned above in the description and the features and feature combinations mentioned hereinafter in the description of the figures and/or solely shown in the single FIGURE are usable not only in the respective specified combination, but rather also in other combinations or alone, without leaving the scope of the invention.

The drawing shows, in the single FIGURE, a detail of a schematic and sectional front view of a motor vehicle according to the invention, which is designed as an automobile, in particular as a passenger vehicle.

The single FIGURE shows a detail in a schematic and sectional front view of a motor vehicle 10 designed as an automobile, in particular as a passenger vehicle, which has a body in the form of a self-supporting vehicle body 12. The motor vehicle 10 has at least one wheel 14, via which the motor vehicle 10 is supportable or supported downward in the vehicle vertical direction on a roadway 16 for the motor vehicle 10. In this case, the vehicle vertical direction is illustrated in the FIGURE by a double arrow 18. In particular, the motor vehicle 10 has multiple wheels, of which the wheel identified by 14 is recognizable in the FIGURE. The motor vehicle 10 preferably has at least or precisely four wheels, wherein the statements above and hereinafter on the wheel 14 can also be transferred readily to the other wheels. The motor vehicle 10 furthermore comprises a wheel suspesion 20, via which the wheel 14 is movably attached to the vehicle body 12. The wheel suspesion 20 permits relative movements between the wheel 14 and the vehicle body 12 at least extending in the vehicle vertical direction, so that the wheel 14 can move upward in relation to the vehicle body 12 in the vehicle vertical direction and can thus be compressed. In addition, for example, the wheel 14 can move downward in the vehicle vertical direction in relation to the vehicle body 12. For this purpose, the wheel suspesion 20 comprises a suspension rod arrangement 22, which has suspension rods 24, 26, and 28 also referred to as wheel suspension rods or guide suspension rods. The suspension rods 26 and 28 are designed, for example, as wishbones and are articulated on one side with the vehicle body 12 and are articulated on the other side with a wheel mount 30 of the wheel suspesion 20, wherein the wheel 14 is rotatably mounted on the wheel mount 30. The suspension rod 24 is coupled in an articulated manner on one side with the vehicle body 12 and is coupled in an articulated manner on the other side with the wheel mount 30. During retractions and extensions of the wheel 14 in relation to the vehicle body 12, the wheel mount 30 can pivot in relation to the suspension rods 24, 26, 28 and overall it is apparent that the wheel 14 is linked via the wheel suspesion 20 to the vehicle body 12.

The wheel suspesion 20 additionally comprises at least one spring element 32, via which the wheel 14 is supportable or supported in a spring-loaded manner on the vehicle body 12. The spring element 32 is designed as a mechanical spring element or as a mechanical spring, so that the spring element 32 is a spring different from a pneumatic spring and thus from an air spring. In particular, the spring element 32 is designed as a coiled spring, in particular as a coiled compression spring.

It has been shown to be particularly advantageous if the spring element 32 is designed as a meandering spring. Since the spring element 32 is designed as a mechanical spring element, the spring element 32 is formed from a solid material, i.e., from a material which exists in the solid phase at a temperature of 25° C. The material from which the spring element 32 is formed is also referred to as a substance, wherein the spring element 32 is intrinsically rigid or dimensionally stable and elastically deformable at the same time.

The spring element 32 designed as a mechanical spring or as a mechanical spring element is supported on one side at least indirectly on the wheel 14 and on the other side at least indirectly on the vehicle body 12. On the wheel side, the spring element 32 is supported via the suspension arm arrangement 22 and via the suspension arm 24 and the wheel mount 30 on the wheel 14. If a retraction of the wheel 14 occurs, which moves in the context of the retraction upward in relation to the body 12 in the vehicle vertical direction, the spring element 32 is thus tensioned, in particular pressed together or compressed. In this way, the spring element 32 provides a spring force, by means of which the wheel 14 can be moved back downward in the vehicle vertical direction in relation to the body 12, whereby the wheel 14 extends, for example. To damp an oscillation of such retraction and extension movements of the wheel 14, for example, a shock absorber (not shown in the FIGURE) is provided, by means of which following relative movements in the vehicle vertical direction between the wheel 14 and the vehicle body 12 are to be damped, i.e., are damped. In particular, the retractions and extensions of the wheel 14 in relation to the vehicle body 12 can be damped by means of the shock absorber. The spring element 32 has a progressive spring characteristic curve, so that the spring element 32 is designed as a progressive suspension spring or progressive body spring. In other words, the spring element 32 has a progressive characteristic. The preferably hydraulic shock absorber is arranged or connected in parallel to the spring element 32 and is coupled on one side at least indirectly to the vehicle body 12 and on the other side indirectly to the wheel 14.

To be able to implement a particularly high level of comfort and a particularly advantageous driving behavior of the motor vehicle 10, the wheel suspesion 20 and thus the motor vehicle 10 comprises a vertical adjustment device 34, by means of which the vehicle body 12 is vertically adjustable, while a change of the spring rate of the spring element 32 does not occur. The feature that the body 12 is vertically adjustable by means of the vertical adjustment device 34, in particular in relation to the roadway 16, is to be understood to mean that the vehicle body 12 can be moved by means of the vertical adjustment device 34 in the vehicle vertical direction in relation to the roadway 16, while the vehicle body 12 is supported via the wheel 14 on the roadway 16.

The FIGURE shows the spring element 32, for example, in a first state, in which the vehicle body 12 or the motor vehicle 10 as a whole is unloaded. If the vehicle body 12 is not loaded, so that the mass of the motor vehicle 10 as a whole increases, the vehicle body 12 thus sinks in the direction of the roadway 16 if initially a vertical adjustment of the vehicle body 12 does not occur. Due to this sinking of the vehicle body 12, the vehicle body 12 moves downward in the vehicle vertical direction in the direction of the roadway 16, whereby the spring element 32 is compressed and thus tensioned starting from the first state. The spring element 32 thus enters a second state, in which the spring element 32 is more strongly compressed and thus more strongly tensioned in relation to the first state. Since the spring element 32 has a progressive spring characteristic curve, the spring rate of the spring element 32 is higher or greater in the second state than in the first state.

In other words, the spring rate of the spring element 32 has a first value in the first state and a second value greater than the first value in the second state, wherein the respective value is a positive greater number in relation to zero or a positive greater value in relation to zero.

To now maintain the greater spring rate, and at the same time to implement a sufficient ground clearance, however, i.e., to implement a sufficient distance extending in the vehicle vertical direction between the vehicle body 12 and the roadway 16, the vehicle body 12 is moved upward away from the roadway 16 in the vehicle vertical direction by means of the vertical adjustment device 34, while the second state of the spring element 32 and thus the spring rate greater than the first state is maintained, i.e., during this a change of the spring rate of the spring element 32 does not occur.

This takes place in the exemplary embodiment illustrated in the FIGURE in that the vertical adjustment device 34 has at least one adjustment element 36. The adjustment element 36 is in particular coupled in an articulated manner on one side at least indirectly, in particular directly, with the spring element 32, in particular with its one end 38. On the other side, the adjustment element 36 is in particular coupled in an articulated manner at least indirectly, in particular directly, with the vehicle body 12. The adjustment element 36 has a first adjustment part 40 and a second adjustment part 42, wherein the adjustment part 40 is coupled with the spring element 32 and the adjustment part 42 is coupled with the vehicle body 12. The adjustment parts 40 and 42 are translationally movable in relation to one another along a movement direction illustrated by a double arrow 44 in the FIGURE, wherein the movement direction extends obliquely or in parallel to the vehicle vertical direction.

The vertical adjustment device 34, in particular the adjustment element 36, has a drive 46, by means of which the adjustment parts 40 and 42 are translationally movable in relation to one another along the movement direction. If, for example, by means of the drive 46, one of the adjustment parts 40 and 42 is translationally moved in relation to the respective other adjustment part 42 or 40, respectively, in a first direction coinciding with the movement direction, thus, for example, the vehicle body 12 is moved upward in the vehicle direction away from the roadway 16, i.e., raised, while a change of the spring rate of the spring element 32 does not occur. If, for example, by means of the drive 46, the one adjustment part 40 or 42 is translationally moved in a direction opposite to the first direction and thus coinciding with the movement direction in relation to the respective other adjustment part 42 or 40, respectively, thus, for example, the body 12 is moved downward in the vehicle vertical direction in the direction of the roadway 16 and thus lowered, while a change of the spring rate of the spring element 32 does not occur. A change of the spring rate of the spring element 32 does not occur during the raising and lowering of the 07780687US vehicle body 12 in particular in that during the lowering or raising of the vehicle body 12, a length change of the spring element 32 does not occur.

This is implemented in that the adjustment element 36 is arranged, with respect to a force flow extending from the vehicle body 12 via the adjustment element 36 and the spring element 32 to the wheel 14 and via this to the roadway 16, between the vehicle body 12 and the spring element 32, so that the adjustment element 36 and the spring element 32 are arranged or connected in series to one another in the described force flow. Alternatively thereto, it would be conceivable that the adjustment element 36 is arranged between the spring element 32 and the wheel 14, so that then the adjustment element 36 and the spring element 32 are also arranged or connected in series to one another in the force flow. The drive 46 is preferably a hydraulic drive, so that the adjustment parts 40 and 42 are translationally movable in relation to one another hydraulically. Furthermore, it can preferably be provided that the drive 46 is an electric drive, so that the drive 46 is designed, for example, as an electric motor. The adjustment parts 40 and 42 are thus translationally movable in relation to one another electrically, for example.

To be able to implement a particularly high level of robustness of the spring element 32, in particular with respect to corrosion, it is preferably provided that the spring element 32 is formed from a glass-fiber-reinforced plastic and thus from a fiber-reinforced plastic.

One of the adjustment parts 40 and 42 has, for example, a piston rod and a piston connected thereto, wherein the respective other adjustment part 42 or 40, respectively, has a cylinder, in which the piston is accommodated so it is translationally movable. The cylinder and the piston form a chamber, which can be supplied, for example, with an operating medium, in particular with a hydraulic liquid. For example, if hydraulic liquid is introduced into the chamber, for example, the piston and the piston rod are thus extended out of the cylinder, whereby a length enlargement or length increase of the adjustment element 36 is effectuated. The vehicle body 12 is raised, for example, by such a length enlargement of the adjustment element 36. If at least a part of the hydraulic liquid initially accommodated in the chamber is discharged from the chamber, the piston and the piston rod are thus retracted into the cylinder, whereby a length shortening or length reduction of the adjustment element 36 is effectuated. The vehicle body 12 is lowered by such a length shortening. The adjustment element 36 thus has, for example, a hydraulic cylinder, by means of which the vehicle body 12 is hydraulically vertically adjustable.

To implement an electrical or electromechanical vertical adjustment of the vehicle body 12, for example, one of the adjustment parts 40 and 42 is designed as a threaded spindle and the respective other adjustment part 42 or 40, respectively, is designed as a nut, which is screwed via respective thread of the nut and the threaded spindle onto the threaded spindle. In the exemplary embodiment illustrated in the FIGURE, for example, the one adjustment part is the adjustment part 40, which is designed as a threaded spindle or has the piston rod and the piston connected thereto. The other adjustment part is, for example, the adjustment part 42, which is thus designed as the mentioned cylinder or as the nut, respectively.

By means of the drive 46, the threaded spindle and the nut can be rotated in relation to one another around the rotational axis, wherein such relative rotations between the threaded spindle and the threaded nut are converted by means of the thread into translational movements between the nut and the threaded spindle. In the context of such a translational relative movement between the nut and the threaded spindle, for example, the nut is translationally moved along the threaded spindle in relation to the threaded spindle. Depending on the direction in which the threaded spindle and the nut are rotated in relation to one another, the vehicle body 12 is then raised or lowered.

To implement a particularly high level of driving comfort, the motor vehicle 10, in particular the wheel suspesion 20, comprises an electronic computing unit 48 schematically shown separately in the FIGURE. In the scope of a method for operating the wheel suspesion 20, for example, a load of the vehicle body 12 is ascertained by means of the electronic computing unit 48. Alternatively or additionally, a retraction state of the wheel 14 in relation to the vehicle body 12 and/or a distance extending in the vehicle vertical direction between the vehicle body 12 and the roadway 16 is ascertained by means of the electronic computing unit 48. In dependence on the ascertained load and/or in dependence on ascertained retraction and/or in dependence on the ascertained distance, the electronic computing unit 48 controls the drive 46, whereby a vertical adjustment of the vehicle body 12 is effectuated, while a change of the spring rate of the spring element 32 does not occur.

In this way, independently of the load, the same ride height and thus the same ground clearance of the motor vehicle 10 can always be implemented, without a person having to be active for this purpose. Since the vertical adjustment takes place without change of the spring rate of the spring element 32, for example, in the loaded state, the greater spring rate of the spring element 32 in relation to the unloaded state can be maintained, so that particularly advantageous driving behavior and a particularly high level of driving comfort can be ensured.

1. (canceled)

12. A wheel suspension for a motor vehicle comprising:
a body and at least one wheel and supportable via the wheel on a roadway, having at least one spring element having a progressive spring characteristic curve, via which the wheel is supportable in a spring-loaded manner on the body,
wherein the vertical adjustment device, by which the body is vertically adjustable, while a change of the spring rate of the spring element does not occur.

13. The wheel suspension as claimed in claim 12, wherein the spring element is formed from a fiber-reinforced plastic.

14. The wheel suspension as claimed in claim 13, wherein the fiber-reinforced plastic is a glass-fiber-reinforced plastic.

15. The wheel suspension as claimed in claim 12, wherein the spring element is designed as a meandering spring.

16. The wheel suspension as claimed in claim 12, wherein the vertical adjustment device has at least one adjustment element, the length of which is adjustable, whereby the body is vertically adjustable, while a change of the spring rate of the spring element does not occur.

17. The wheel suspension as claimed in claim 15, wherein the adjustment element is arranged, with respect to a force flow extending from the body via the spring element and the adjustment element to the wheel, between the body and the spring element or between the wheel and the spring element.

18. The wheel suspension as claimed in claim 12, wherein the vertical adjustment device is hydraulically and/or electrically operable, so that the body is hydraulically and/or electromechanically vertically adjustable.

19. The wheel suspension as claimed in claim 12, wherein the wheel suspension comprises the body and the wheel.

20. The wheel suspension as claimed in claim 12, wherein an electronic computing unit, which is designed to ascertain a load of the body, to control the vertical adjustment device in dependence on the ascertained load, and thus to effectuate a vertical adjustment of the body, while a change of the spring rate of the spring element does not occur.

21. A motor vehicle, comprising:
a body, having at least one wheel, via which the body is supportable on a roadway for the motor vehicle, and having a wheel suspension, which has at least one spring element having a progressive spring characteristic curve, via which the wheel is supported in a spring-loaded manner on the body,
wherein a vertical adjustment device, by which the body is vertically adjustable, while a change of the spring rate of the spring element does not occur.

22. A method for operating a wheel suspension of a motor vehicle comprising:
a body and at least one wheel and is supportable via the wheels on a roadway, having at least one spring element having a progressive spring characteristic curve, via which the wheel is supported in a spring-loaded manner on the body, wherein the body is vertically adjusted by means of a vertical adjustment device of the motor vehicle, while a change of the spring rate of the spring element does not occur.

23. The wheel suspension as claimed in claim 13, wherein the spring element is designed as a meandering spring.

24. The wheel suspension as claimed in claim 14, wherein the spring element is designed as a meandering spring.

25. The wheel suspension as claimed in claim 13, wherein the vertical adjustment device has at least one adjustment element, the length of which is adjustable, whereby the body is vertically adjustable, while a change of the spring rate of the spring element does not occur.

26. The wheel suspension as claimed in claim 14, wherein the vertical adjustment device has at least one adjustment element, the length of which is adjustable, whereby the body is vertically adjustable, while a change of the spring rate of the spring element does not occur.

27. The wheel suspension as claimed in claim 15, wherein the vertical adjustment device has at least one adjustment element, the length of which is adjustable, whereby the body is vertically adjustable, while a change of the spring rate of the spring element does not occur.

28. The wheel suspension as claimed in claim 13, wherein the adjustment element is arranged, with respect to a force flow extending from the body via the spring element and the adjustment element to the wheel, between the body and the spring element or between the wheel and the spring element.

29. The wheel suspension as claimed in claim 14, wherein the adjustment element is arranged, with respect to a force flow extending from the body via the spring element and the adjustment element to the wheel, between the body and the spring element or between the wheel and the spring element.

30. The wheel suspension as claimed in claim 16, wherein the adjustment element is arranged, with respect to a force flow extending from the body via the spring element and the adjustment element to the wheel, between the body and the spring element or between the wheel and the spring element.
